(19) United States
(12) Patent Application Publication
(10) Pub. No.: US 2024/0115084 A1
(43) Pub. Date: Apr. 11, 2024

(54) WIPES DISPENSER WITH A SUCTION CUP MOUNTED THERETO

(71) Applicant: Clifford A. Lott, SR., Aurora, CO (US)

(72) Inventor: Clifford A. Lott, SR., Aurora, CO (US)

(21) Appl. No.: 17/962,842

(22) Filed: Oct. 10, 2022

(51) Int. Cl. A47K 10/32; F16B 47/00

(52) U.S. Cl. CPC A47K 10/32; F16B 47/00; A47K 2010/3233

(57) ABSTRACT

A wipes dispenser with a suction cup adapted to be removably attached to a flat surface to secure the wipes dispenser. The suction cup has a working face forming the bottom surface of the suction cup. The working face of the suction cup is made of an elastic, flexible material is formed with a curved surface. The top surface of the suction cup has a threaded cylindrical base projecting upward therefrom. The threaded cylindrical base is inserted into a threaded female coupling formed in the bottom end enclosure mounted to the bottom end of the wipes dispenser. The bottom end enclosure closes the bottom end of the wipes dispenser so that the latter can be readily accessible.

### TECHNICAL FIELD OF THE INVENTION

The present invention relates generally to a wipes dispenser with a suction cup mounted thereto and more specifically to a sanitized wipes dispenser having a suction cup mounted to the base thereof whereby the sanitized wipes dispenser can be secured to a smooth surface by the suction cup device.

### DESCRIPTION OF PRIOR ART

In many applications there is a need to temporarily hold a dispenser container of some type. A major requirement of this is for the holder to be mobile and able to be easily fastened to many surfaces, and to accept different types and sizes of dispensers and containers.

Heretofore many different dispenser holders were used so they could be mounted to a surface. One type involved an insulated container holder secured to an intended mounting surface by cooperating hook and loop type fasteners. However, in these arrangements the hook and loop fasteners are permanently adhered to a horizontal surface, thus limiting the mounting location of the beverage container holder to that specific location.

Another arrangement comprises a base for holding bottles or the like, however it does not provide the ability for securing to a surface and is limited to one size and type of container.

In still another type, a gimbled receptacle for dispensers allows for a variety of types and sizes of containers. The holder requires permanent mounting (by way of screws) to a vertical surface, thus limiting the mounting location of the beverage container holder to the location.

### SUMMARY OF THE INVENTION

According to an embodiment of the present invention, there is disclosed a wipes dispenser with a suction cup adapted to be removably attached to a flat surface to secure the wipes dispenser. The suction cup has a working face forming the bottom surface of the suction cup. The working face of the suction cup is made of an elastic, flexible material is formed with a curved surface. The top surface of the suction cup has a threaded cylindrical base projecting upward therefrom. The threaded cylindrical base is inserted into a threaded female coupling formed in the bottom end enclosure mounted to the bottom end of the wipes dispenser. The bottom end enclosure closes the bottom end of the wipes dispenser so that the latter can be readily accessible.

According to another embodiment of the present invention, there is disclosed a wipes dispenser with a suction cup adapted to be removably attached to a flat surface to secure the wipes dispenser. The suction cup permanently mounted thereto to the wipes dispenser. The suction cup having a working face forming the bottom surface of the suction cup. The working face of the suction cup is made of an elastic, flexible material is formed with a curved surface. The end enclosure mounted to the bottom end of the wipes dispenser. The bottom end enclosure closes the bottom end of the wipes dispenser so that the latter can be readily accessible.

### BRIEF DESCRIPTION OF THE DRAWINGS

The structure, operation, and advantages of the present invention will become further apparent upon consideration of the following description taken in conjunction with the accompanying figures (FIGs.). The figures are intended to be illustrative, not limiting. Certain elements in some of the figures may be omitted, or illustrated not-to-scale, for illustrative clarity. The cross-sectional views may be in the form of “slices”, or “near-sighted” cross-sectional views, omitting certain background lines which would otherwise be visible in a “true” cross-sectional view, for illustrative clarity.

In the drawings accompanying the description that follows, both reference numerals and legends (labels, text descriptions) may be used to identify elements. If legends are provided, they are intended merely as an aid to the reader, and should not in any way be interpreted as limiting.

These and other objects of the present invention will become apparent, particularly when taken in light of the following illustrations wherein:

FIG. 1 is a side, three-dimensional exploded view of the body components of a first embodiment of a wipes dispenser having a suction cup removably mounted to the base thereof, in accordance with the present invention.

FIG. 2 is a three-dimensional side view of the suction cup, in accordance with the present invention.

FIG. 3 is a side view showing the suction cup, in accordance with the present invention.

FIG. 4 is a bottom view of the wipes dispenser, in accordance with the present invention.

FIG. 5 is an orthographic bottom view of the bottom of the wipes dispenser and the suction cup, in accordance with the present invention.

FIG. 6 is a side, three-dimensional exploded view of the body components of a second embodiment of a wipes dispenser having a suction cup incorporated in the base thereof, in accordance with the present invention.

FIG. 7 is an orthographic bottom view of the bottom of the wipes dispenser and the suction cup of the second embodiment of a wipes dispenser having a suction cup incorporated in the base thereof, in accordance with the present invention.

### DETAILED DESCRIPTION OF THE PREFERRED EMBODIMENTS

In the description that follows, numerous details are set forth in order to provide a thorough understanding of the present invention. It will be appreciated by those skilled in the art that variations of these specific details are possible while still achieving the results of the present invention. Well-known processing steps are generally not described in detail in order to avoid unnecessarily obfuscating the description of the present invention.

In the description that follows, exemplary dimensions may be presented for an illustrative embodiment of the invention. The dimensions should not be interpreted as limiting. They are included to provide a sense of proportion. Generally speaking, it is the relationship between various elements, where they are located, their contrasting compositions, and sometimes their relative sizes that is of significance.

In the drawings accompanying the description that follows, often both reference numerals and legends (labels, text descriptions) will be used to identify elements. If legends are provided, they are intended merely as an aid to the reader, and should not in any way be interpreted as limiting.

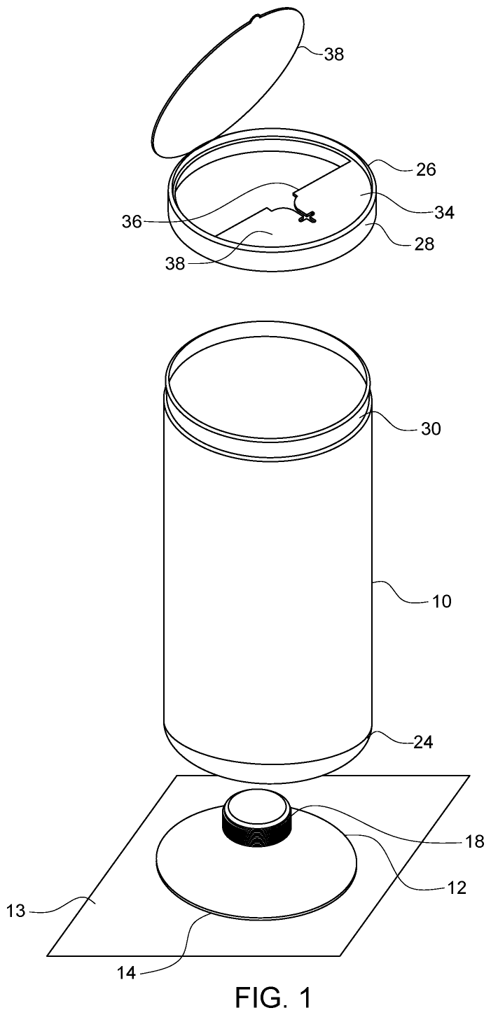

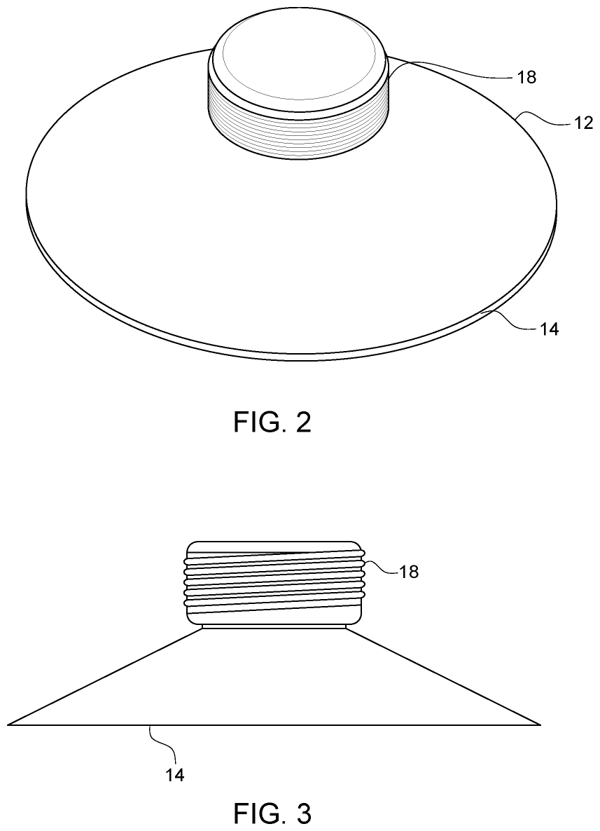

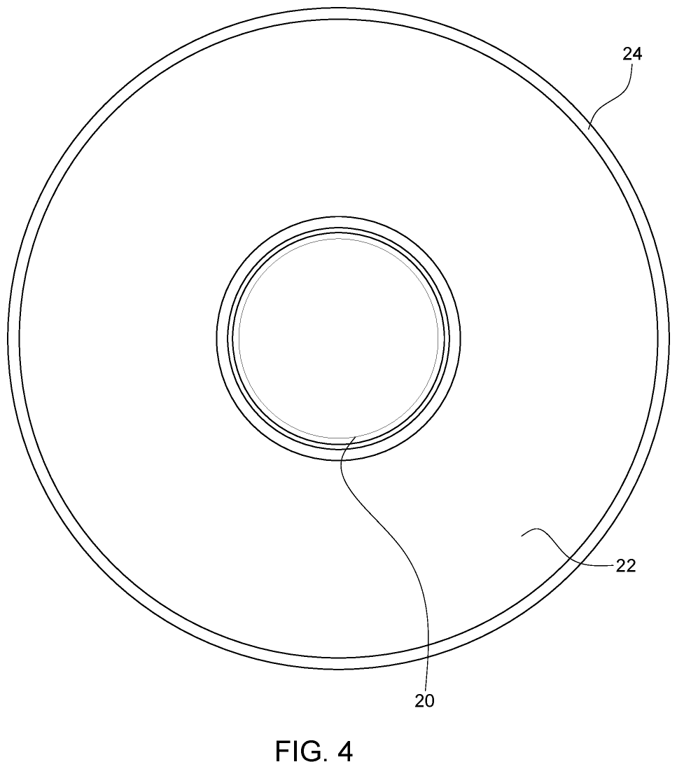

Referring to FIG. 1, there is illustrated a wipes dispenser 10 with a suction cup 12 mounted thereto. The suction cup 12 can be removably attached to a flat and often smooth surface 13 to secure the wipes dispenser 10.

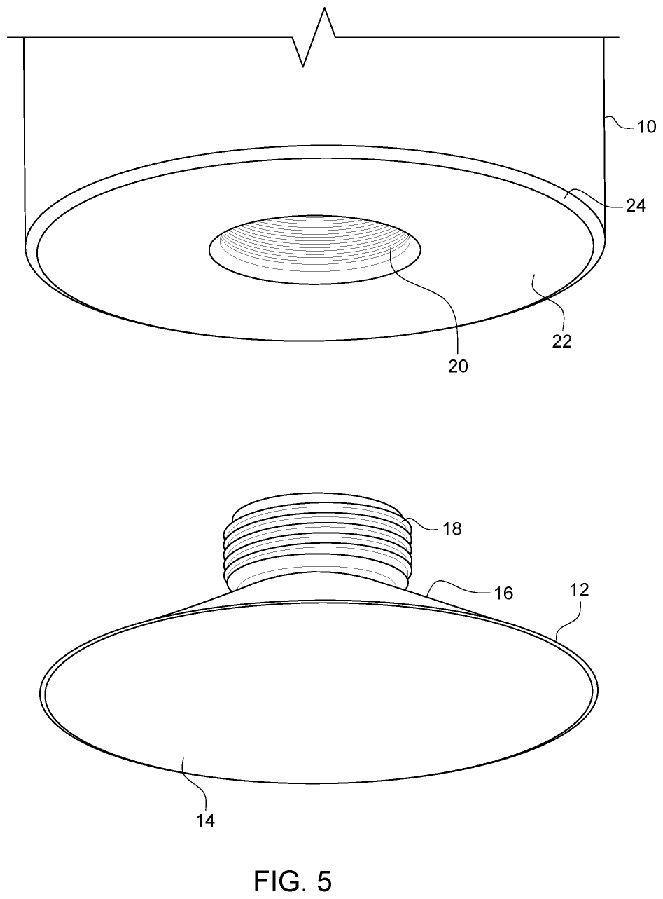

The suction cup 12 has a working face 14 forming the bottom surface of the suction cup. The working face 14 of the suction cup 12 is made of an elastic, flexible material and has a curved surface, as shown in FIG. 5. The top surface 16 of the suction cup 12 has a threaded cylindrical base 18 projecting upward therefrom. The threaded cylindrical base 18 is inserted into a threaded female coupling 20 formed in the bottom end enclosure 22 mounted to the bottom end 24 of the wipes dispenser 10. The bottom end enclosure 22 closes the bottom end 24 of the wipes dispenser 10 so that the latter can be readily accessible.

Referring again to FIG. 1, the wipes dispenser 10 is a hollow cylindrical container having a bottom end closure 22 and a circular, top end closure 26 having a cylindrical wall 28 which mounts onto a collar 30 formed about the top end 32 of the wipes dispenser 10. The collar 30 has an outer diameter which is slightly less than the inner diameter of the end closure 26 so that the end closure has a friction fit with the collar 30. The top end closure 26 has a semicircular section 34 which forms a partial spill proof section which extends across about ½ of the top end closure 26. The semicircular section 34 includes a cutout 36 that allows the user to tear off the wipe (not shown). The top end closure 26 also includes a lid 38 that is pivotally mounted to the cylindrical wall 28. The lid 38 has an outer diameter which is slightly less that the inner diameter of the wall 28 so that the lid can be closed into the opening formed by the inner diameter of the wall and the top surface 38 of the section 34.

When the center of the suction cup 12 is pressed against a flat, non-porous surface 13, the volume of the space between the suction cup 12 and the flat surface is reduced, which causes the air between the cup and the surface to be expelled past the rim of the circular cup. The cavity which develops between the cup and the flat surface has little or no air in it because most of the fluid has already been forced out of the inside of the cup, causing a lack of pressure. The pressure difference between the atmosphere on the outside of the cup and the low-pressure cavity on the inside of the cup keeps the cup adhered to the surface.

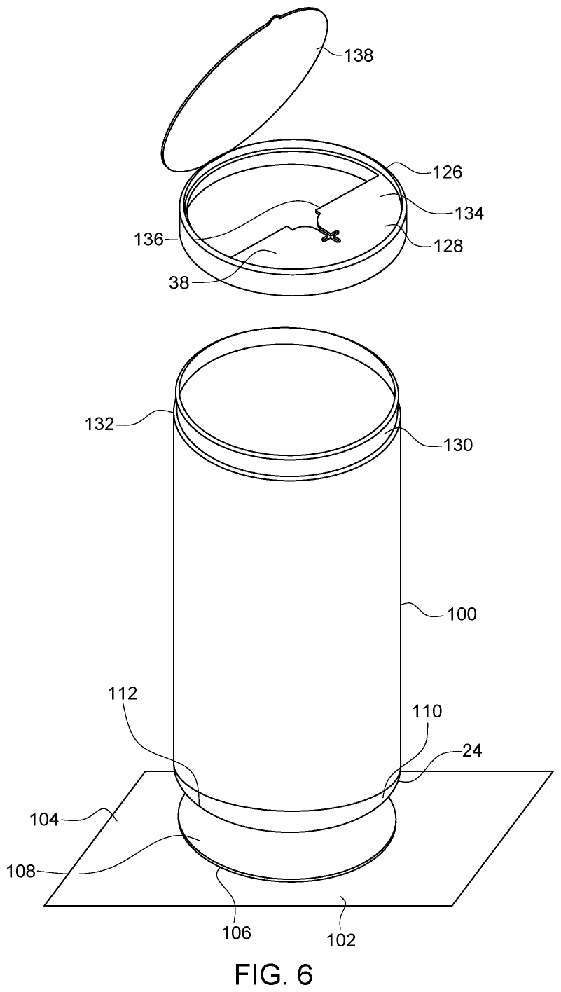

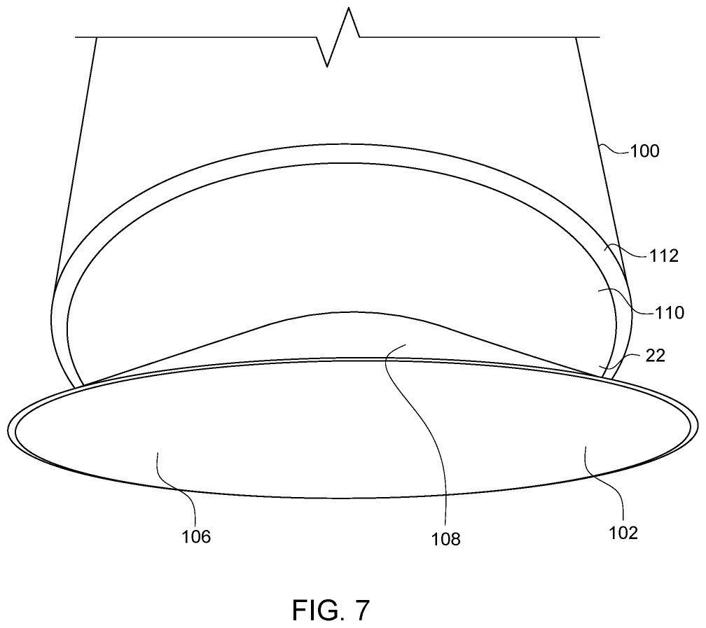

Referring to FIGS. 6 and 7, there is illustrated a second embodiment of the invention of a wipes dispenser 100 with a suction cup 102 permanently mounted thereto. The suction cup 102 can be removably attached to a flat and often smooth surface 104 to secure the wipes dispenser 100.

The suction cup 102 has a working face 106 forming the bottom surface of the suction cup. The working face 106 of the suction cup 102 is made of an elastic, flexible material and has a curved surface, as shown in FIG. 7. The top surface 108 of the suction cup 102 is secured to the bottom end enclosure 110 mounted to the bottom end 112 of the wipes dispenser 100. The bottom end enclosure 110 closes the bottom end 112 of the wipes dispenser 100 so that the latter can adhered to the surface.

Referring again to FIGS. 6 and 7, the wipes dispenser 100 of the second embodiment is a hollow cylindrical container having a bottom end closure 110 and a circular, top end closure 126 having a cylindrical wall 128 which mounts onto a collar 130 formed about the top end 132 of the wipes dispenser 100. The collar 130 has an outer diameter which is slightly less than the inner diameter of the end closure 126 so that the end closure has a friction fit with the collar 130. The top end closure 126 has a semicircular section 134 which forms a partial spill proof section inch extends across about ½ of the top end closure 126. The semicircular section 134 includes a cutout 136 that can receive a wipe (not shown). The top end closure 126 also includes a lid 138 that is pivotally mounted to the cylindrical wall 128. The lid 138 has an outer diameter which is slightly less that the inner diameter of the wall 128 so that the lid can be closed into the opening formed by the inner diameter of the wall and the top surface 138 of the section 134.

Although the invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components (assemblies, devices, etc.) the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

1. A wipes dispenser with a suction cup adapted to be removably attached to a flat surface to secure the wipes dispenser:
the suction cup has a working face forming a bottom surface of the suction cup;
the working face of the suction cup is made of an elastic, flexible material and formed with a curved surface;
a top surface of the suction cup has a threaded cylindrical base projecting upward therefrom; and
the threaded cylindrical base is inserted into a threaded female coupling formed in a bottom end of the wipes dispenser; and
a bottom end enclosure closes the bottom end of the wipes dispenser.

2. The wipes dispenser of claim 1 wherein the wipes dispenser is a hollow cylindrical container having the bottom end closure and a circular, top end closure having a cylindrical wall which mounts onto a collar formed about a top end of the wipes dispenser.

3. The wipes dispenser of claim 2 wherein the collar formed about the top end of the wipes dispenser has an outer diameter which is less than an inner diameter of the top end closure so that the top end closure has a friction fit with the collar.

4. The wipes dispenser of claim 3 wherein the top end closure has a semicircular section which forms a tear section which extends across about ½ of the top end closure.

5. The wipes dispenser of claim 4 wherein the semicircular section includes a cutout section that allows a user to tear off a wipe caught in the cutout section.

6. The wipes dispenser of claim 5 wherein the top end closure also includes a lid that is pivotally mounted to the cylindrical wall of the circular, top end closure.

7. The wipes dispenser of claim 6 wherein the lid has an outer diameter which is less than the inner diameter of the cylindrical wall so that the lid can be closed into an opening formed by the inner diameter of the cylindrical wall.

8. The wipes dispenser of claim 7 wherein a center portion of the suction cup is pressed against a flat, non-porous surface.

9. The wipes dispenser of claim 8 wherein when the center portion of the suction cup is pressed against a flat, non-porous surface, the volume of the space between the suction cup and the flat surface is reduced, whereby air between the suction cup and the flat, non-porous surface is expelled past an outer rim of the suction cup.

10. The wipes dispenser of claim 9 wherein a cavity which forms between the suction cup and the flat surface has little or no air because the air is forced out of the inside of the suction cup, causing a lack of pressure.

11. The wipes dispenser of claim 10 wherein a pressure difference between the air outside of the suction cup and the cavity formed on the inside of the suction cup keeps the suction cup adhered to the surface.

12. A wipes dispenser with a suction cup adapted to be removably attached to a flat surface to secure the wipes dispenser:
the suction cup permanently mounted to the wipes dispenser;
the suction cup having a working face forming the bottom surface of the suction cup;
the working face of the suction cup is made of an elastic, flexible material and formed with a curved surface;
a bottom end enclosure mounted to a bottom end of the wipes dispenser; and
the bottom end enclosure closes the bottom end of the wipes dispenser.

13. The wipes dispenser of claim 12 wherein the suction cup can be removably attached to a flat, smooth surface to secure the wipes dispenser.

14. The wipes dispenser of claim 13 wherein the top surface of the suction cup is secured to the bottom end enclosure mounted to the bottom end of the wipes dispenser.

15. The wipes dispenser of claim 14 wherein the bottom end enclosure closes the bottom end of the wipes dispenser so that the latter can adhered to the flat surface.

16. The wipes dispenser of claim 15 wherein the wipes dispenser is a hollow cylindrical container having a bottom end closure and a circular, top end closure having a cylindrical wall which mounts onto a collar formed about the top end of the wipes dispenser.

17. The wipes dispenser of claim 16 wherein the collar has an outer diameter which is slightly less than the inner diameter of the top end closure so that the top end closure has a friction fit with the collar.

18. The wipes dispenser of claim 17 wherein the top end closure includes a lid that is pivotally mounted to the cylindrical wall so that the lid can be closed into the opening formed by the inner diameter of the cylindrical wall.

19. The wipes dispenser of claim 18 wherein when the center portion of the suction cup is pressed against a flat, non-porous surface, the volume of the space between the suction cup and the flat surface is reduced, whereby air between the suction cup and the flat, non-porous surface is expelled past an outer rim of the suction cup.

20. The wipes dispenser of claim 19 wherein a cavity which forms between the suction cup and the flat surface has little or no air because the air is forced out of the inside of the suction cup, causing a lack of pressure.
